(19) United States
(12) Patent Application Publication
(10) Pub. No.: US 2025/0250036 A1
(43) Pub. Date: Aug. 7, 2025

(54) SYSTEM FOR INSPECTION OF A REGION AND METHOD THEREOF

(71) Applicant: ideaForge Technology Limited, Navi Mumbai (IN)

(72) Inventor: Ankit MEHTA, Navi Mumbai (IN)

(21) Appl. No.: 19/042,416

(22) Filed: Jan. 31, 2025

(30) Foreign Application Priority Data
Feb. 1, 2024 (IN) 202421006806

(51) Int. Cl. B64U 70/20; B64U 10/60; B64U 80/82; B64U 101/31

(52) U.S. Cl. CPC B64U 70/20; B64U 10/60; B64U 80/82; B64U 2101/31

(57) ABSTRACT

A system and a method for inspection of a Region of Interest (210) include a first Unmanned Aerial Vehicle (UAV) (102) and a second UAV (104). The first UAV (102) is configured to manoeuvre to the RoI (210), and the second UAV (104) is physically coupled with the first UAV (102) through a tether and winch mechanism (106). Upon reaching the RoI (210), the second UAV (104) is configured to move from a stowed position to a deployed position with respect to the first UAV (102), such that the second UAV (104), in the deployed position, is configured to move down from the first UAV (102), and collect, through sensors (110) integrated with the second UAV (104), data associated with the RoI (210).

### TECHNICAL FIELD

The present disclosure relates to the field of Unmanned Aerial Vehicles (UAVs). In particular, the present disclosure relates to navigation of UAVs. More particularly, it pertains to a system for inspection of a region and a method thereof.

### BACKGROUND

Background description includes information that may be useful in understanding the present invention. It is not an admission that any of the information provided herein is prior art or relevant to the presently claimed invention, or that any publication specifically or implicitly referenced is prior art.

The term ‘unmanned aerial vehicle’ (UAV) refers to an aircraft that may operate and fly without any human pilot, crew, or passengers therein. Basically, UAVs constitute a type of aerial vehicles that can be controlled and remotely operated through ground-based remote controllers and communication devices. The UAVs are also known as drones and are an essential asset for law enforcement agencies and military personnel. However, the UAVs can play a crucial role in non-military areas, such as forest fire monitoring, aerial photography, product deliveries, agriculture, infrastructure inspections, science, and drone racing. Generally, conventional UAVs are operated through remote drone operators.

Typically, for safety reasons over populated areas, small UAVs are employed for inspecting structures, such as telecommunication towers atop high-rise buildings. But their limited endurance due to smaller battery sizes becomes a major hindrance as these UAVs cannot cover long distances or operate for extended periods, necessitating manual transportation to specific locations, especially in scenarios involving elevated structures. Human intervention is required to move the UAV to the inspection site, adding complexity and additional effort for UAV pilot personnel. The distance constraints of small UAVs also pose challenges, as they may not reach inspection sites located far from the launch point. While using larger UAVs with increased endurance might address this, navigating through complex structures with narrow spaces remains problematic.

There is, therefore, a need in the art to provide a smart, effective, and user-friendly solution for obviating the above-mentioned problems and providing a solution for minimizing human efforts while enabling inspection of complex and over-populated regions.

### OBJECTS OF THE PRESENT DISCLOSURE

A general object of the present disclosure is to provide an effective solution for accurate inspection of distinct regions.

An object of the present disclosure is to minimize manual intervention during the inspection of structures.

Another object of the present disclosure is to optimize the UAV system for greater autonomy, longer endurance, and improved adaptability.

Another object of the present disclosure is to prevent potential damages to the UAVs during inspection of structures.

Yet another object of the present disclosure is to efficiently cover long distances, complex terrains, and operate for extended time duration, during inspection of structures using UAVs.

### SUMMARY

An aspect of the present disclosure pertains to a system for inspection of a Region of Interest (RoI). The system comprises a first Unmanned Aerial Vehicle (UAV) configured to manoeuvre to the RoI; and a second UAV physically coupled with the first UAV Upon reaching the RoI, the second UAV is configured to move from a stowed position to a deployed position with respect to the first UAV, wherein the second UAV, in the deployed position, is configured to move down from the first UAV (102) through a physical link, and collect, through one or more sensors integrated with the second UAV, data associated with the RoI.

In an aspect, the physical link is a tether driven by a winch mechanism provided at the first UAV.

In another aspect, in the event of an emergency, the second UAV may be configured to get detached from tether and soft land through any or a combination of a propulsion module and a parachute provided with the second UAV.

In another aspect, the winch mechanism may include a dampening element to prevent swaying of the tether due to wind.

In an aspect, when wind speed is detected to be above a threshold level, the second UAV may trigger an alert signal, and correspondingly the first UAV may facilitate the second UAV to detach from the tether for safe landing.

In an aspect, in the deployed position of the second UAV, the system may be configured to maintain desired horizontal coordinates of the second UAV

In an aspect, the second UAV may identify deflections in the tether caused due to wind and may transmit a corresponding feedback to the first UAV for compensating the deflections by changing its own position.

In an aspect, the first UAV and the second UAV may be configured to interact with each other through a communication module, wherein the first UAV may determine horizontal coordinates for manoeuvring and may transmit corresponding information to the second UAV through the communication module, and further, through controlled actuation of the winch mechanism, the second UAV may move vertically for efficiently collecting the data associated with the RoI.

In an aspect, the first UAV and the second UAV may be configured to interact with each other through a communication module, wherein the second UAV may determine horizontal coordinates for manoeuvring, and may move vertically, through controlled actuation of the tether and winch mechanism, for efficiently collecting the data associated with the RoI, and may further transmit corresponding information to the first UAV through the communication module.

In an aspect, the first UAV and the second UAV may be in communication with a ground control station through one or more sets of transceivers, which may facilitate dual path communication in between the first UAV and/or the second UAV and the ground control station.

In an aspect, the second UAV may be circumscribed with an outer cage for providing enhanced safety to the second UAV.

In an aspect, the second UAV may move between the stowed position and the deployed position and may control operations of the one or more sensors integrated along with through electrical power supplied from any or a combination of the first UAV and a power supply module integrated within the second UAV

Another aspect of the present disclosure pertains to a method for inspection of a Region of Interest (RoI). The method includes: (i) manoeuvring, a first Unmanned Aerial Vehicle (UAV), to the RoI; and (ii) moving, a second UAV, physically coupled with the first UAV, from a stowed position to a deployed position with respect to the first UAV, wherein upon reaching the RoI, the second UAV, in the deployed position, is configured to move down from the first UAV through a physical link, and collect, through one or more sensors integrated with the second UAV, data associated with the RoI.

In an aspect, the physical link is a tether driven by a winch mechanism provided at the first UAV. In the event of an emergency, the method may include detaching the second UAV from the tether and enabling soft landing through any or a combination of a propulsion module and a parachute provided with the second UAV

In one aspect, the method may include preventing, through a dampening element associated with the tether and winch mechanism, swaying of the tether due to wind.

In another aspect, when wind speed is detected to be above a threshold level, the method may include triggering, through the second UAV, an alert signal, and correspondingly facilitating the second UAV to detach from the tether for safe landing.

In an aspect, in the deployed position of the second UAV, the method may include maintaining desired horizontal coordinates of the second UAV.

In one aspect, the method may include identifying, through the second UAV, deflections in the tether caused due to wind and transmitting a corresponding feedback to the first UAV for compensating the deflections by changing its own position.

In an aspect, the method may include enabling the first UAV and the second UAV to interact with each other through a communication module, wherein the first UAV may determine horizontal coordinates for manoeuvring and may transmit corresponding information to the second UAV through the communication module, and further, through controlled actuation of the winch mechanism, the second UAV may move vertically for efficiently collecting the data associated with the RoI.

In an aspect, the method may include enabling the first UAV and the second UAV to interact with each other through a communication module, wherein the second UAV may determine horizontal coordinates for manoeuvring, and may move vertically, through controlled actuation of the winch mechanism, for efficiently collecting the data associated with the RoI, and may further transmit corresponding information to the first UAV through the communication module.

In an aspect, the method may include supplying required electric power from any or a combination of the first UAV and a power supply module integrated within the second UAV to the second UAV for facilitating movement between the stowed position and the deployed position and controlling operations of the one or more sensors integrated along with.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1 illustrates an exemplary block diagram of the proposed system for inspection of a region, in order to elaborate its overall working, in accordance with an embodiment of the present invention.

FIG. 2 illustrates an exemplary schematic arrangement showing UAVs associated with the system of FIG. 1, in accordance with an embodiment of the present invention.

FIG. 3 illustrates an exemplary diagram representing communication taking place between the UAVs and ground control base, in accordance with an embodiment of the present invention.

FIG. 4 illustrates a flow diagram of the proposed method for inspection of a region, in accordance with an embodiment of the present invention.

### DETAILED DESCRIPTION OF THE PRESENT INVENTION

The following is a detailed description of embodiments of the disclosure represented in the accompanying drawings. The disclosed embodiments are merely exemplary of the invention, which may be embodied in various forms. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

The present disclosure relates to the field of Unmanned Aerial Vehicles (UAVs). More particularly, it pertains to a system for inspection of a region and a method thereof.

Embodiments of the present disclosure relate to an effective solution for accurate inspection of distinct regions with negligible or minimum manual intervention. It provides an optimized UAV design for greater autonomy, longer endurance, and improved adaptability for efficiently covering long distances, complex terrains, and operate for extended time duration. It provides for two UAVs, where the larger UAV provides increased endurance and the smaller UAV facilitates easy inspection of complex regions, densely populated areas, cell towers, buildings, gas pipelines, hazardous regions, nuclear radiator sites, and the like.

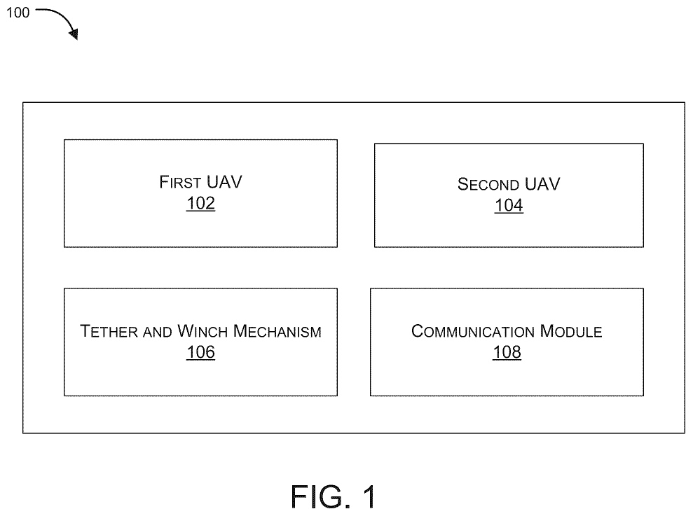

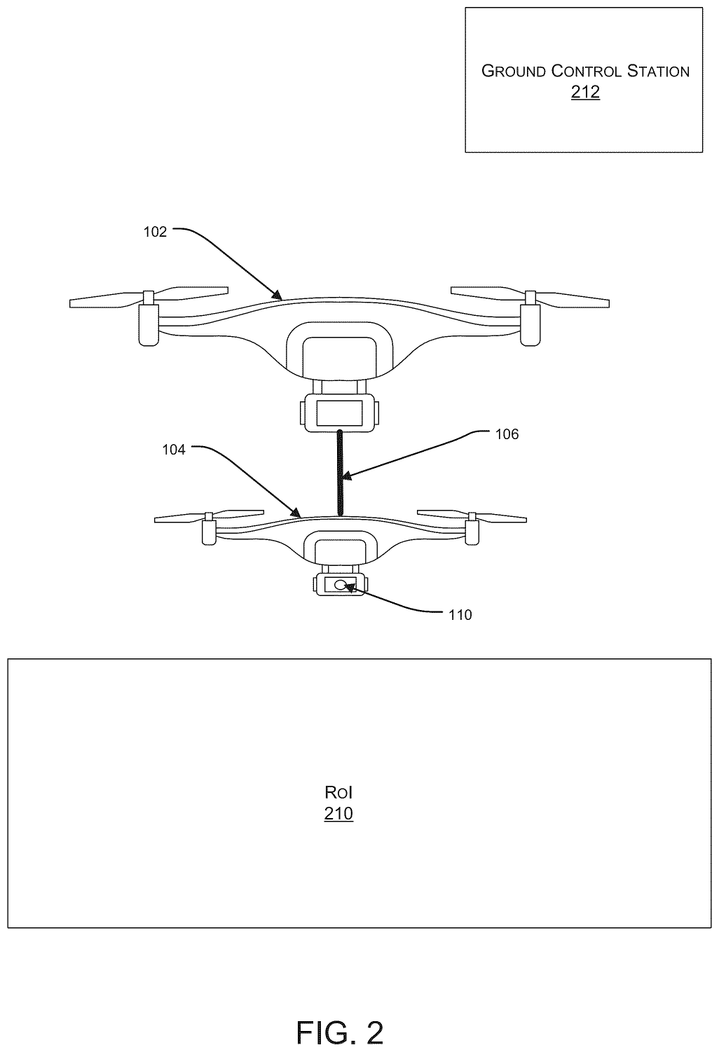

Referring to FIG. 1, the proposed system 100 for inspection of a Region of Interest (RoI) (also, referred to as system 100, herein) can be utilized for inspection of a Region of Interest (RoI) 210 (as illustrate in FIG. 2), such as remote terrain, complex topography, unknown landscapes, overpopulated areas, congested regions, skyscrapers, multi-story buildings, towers, and the like. The system 100 includes a first UAV 102 (interchangeably, referred to as UAV 102, herein) and a second UAV 104 (interchangeably, referred to as UAV 104, herein) physically coupled with the first UAV 102. In an exemplary embodiment, the UAV 102 is larger compared to the UAV 104 with higher endurance and capabilities, and the UAV 104 is smaller with limited endurance and propulsion capabilities, and can be attached as a payload to the UAV 102.

In an embodiment, the UAV 102 is initially located at a remotely located UAV dock station. Upon being triggered by sets of signals transmitted from the UAV dock station, where the sets of signals pertain to location and trajectory of the RoI 210, the UAV 102 can be configured to take flight from the UAV dock station and manoeuvre to the RoI 210, and upon reaching the RoI, the second UAV 104 is configured to move from a stowed position to a deployed position with respect to the first UAV 102. In one embodiment, in the deployed position, the second UAV 104 is configured to move down from the first UAV 102 through a physical link, and collect, through one or more sensors 110 (as illustrated in FIG. 2) including, but not limited to camera, RADAR, LiDAR, integrated with the second UAV 104, data associated with the RoI 210. In an exemplary embodiment, the camera can be selected from any of daylight RGB camera, thermal camera, multispectral camera, hyperspectral camera, ultrasonic camera, and the like.

In an implementation, the UAV 104 may include a power supply module, which may be integrated within the UAV 104 for endurance. Alternatively, the UAV 104 can receive power and communication from the UAV 102 wirelessly. The UAV 104 may move between the stowed position and the deployed position and may control operations of the one or more sensors 110 integrated along with through electrical power supplied from any of the UAV 102 and the power supply module integrated within the UAV 104. In an exemplary embodiment, controlling the operations of the one or more sensors 110 may include pitch, tilt, and yaw of the camera, LiDAR, RADAR, etc. Further, in case of camera, the system 100 may also control corresponding zoom level. Hence, the proposed system 100 enables optimization of UAV design for greater autonomy, longer endurance, and improved adaptability, and also to enable the UAVs 102 and 104 to efficiently cover long distances, complex terrains, and operate for extended time duration.

In an embodiment, the UAV 104 may be coupled to the UAV 102 by a tether driven by a winch mechanism 106 (interchangeably, referred to as tether and winch mechanism 106, herein), which may be preferably provided at the UAV 102. However, having the tether and winch mechanism 106 on the second UAV 104 with the tether coupled to the first UAV 102, and the second UAV 104 controlling the operation of the winch is well within the scope of the present disclosure. In an implementation, base of the tether and winch mechanism 106 can be configured at the UAV 102 and corresponding tether can be detachably coupled with the UAV 104, facilitating the UAV 104 to carry out upward and downward movement securely with respect to the UAV 102. It should be appreciated that the UAV 104 may be coupled to the UAV 102 through means other than the tether and winch mechanism 106, such as suspension assembly, and other similar mechanism, which may be provided to selectively alter relative vertical distance between the UAV 104 and the UAV 102, and are equally efficient and well within the scope of the present invention. Further, the tether lines may be in form of wire, rod, string, spring, and the like.

In an embodiment, the UAV 102 and the UAV 104 may be configured to interact with each other via a communication module 108 preferably through wireless communication channels including, but not limited to, Wi-Fi, Bluetooth, GSM, 4G, 5G, LoRa, NFC (Near Field Communication), and LTE.

In an embodiment, in the deployed position of the second UAV 104, the system 100 may be configured to maintain desired horizontal coordinates of the second UAV 104. In an exemplary embodiment, the desired horizontal coordinates may pertain to horizontal coordinates closely or substantially equal to the horizontal coordinates of the first UAV 102. In another exemplary embodiment, the second UAV 104 may be configured to move downwards maintaining same horizontal coordinates as that of the first UAV 102 for carrying out inspection and survey of the RoI 210.

In one embodiment, the UAV 102 may determine horizontal coordinates for manoeuvring and may transmit corresponding information to the UAV 104 through the communication module 108, and further, through controlled actuation of the tether and winch mechanism 106, the UAV 104 may move vertically mimicking the horizontal coordinates of the UAV 102 for efficiently collecting the data associated with the RoI 210.

In other embodiment, the UAV 104 may determine horizontal coordinates for manoeuvring and may move vertically, through controlled actuation of the tether and winch mechanism 106, for efficiently collecting the data associated with the RoI 210, and may further transmit corresponding information to the UAV 102 through the communication module 108. The UAV 104 can move vertically with respect to the UAV 102 adjusting altitude by reeling in and out through the tether and winch mechanism 106 for carrying out the inspection efficiently and also for handling emergencies.

Hence, both the UAV 102 and the UAV 104 can mimic each other and trigger horizontal movement in each other whenever required. In an exemplary embodiment, in case the UAV 104 detects an obstacle through corresponding sensors 110, the UAV 104 can send a feedback signal indicating presence of the obstacle to the UAV 102, and further the UAV 102 can rectify its horizontal coordinates, which is further mimicked by the UAV 104. Moreover, the UAV 102 and the UAV 104 both can trigger horizontal movement control for each other based on feedback mechanism.

In an implementation, mimicking process of the UAVs 102 and 104 may involve any of the following two techniques—
In first technique, microprocessors associated with the UAV 102 and UAV 104 can be synchronized and may operate at a single frequency, hence when control commands are transmitted from the dock station to the UAV 102, same control commands are also transmitted to the UAV 104, simultaneously. Hence, the UAV 104 mimics the movement of the UAV 102.
In second technique, there can be a motion sensing unit (motion detector) present on the UAV 104, and may detect motion of the UAV 102 and correspondingly send data pertaining to the detected movement to the microprocessor of the UAV 104, which may then mimic the movement of the UAV 102 based on the data captured by the motion sensing unit.

In another embodiment, the UAV 102 and the UAV 104 can be in communication with a ground control station 212 associated with the UAV dock station. In an implementation, the UAVs 102 and 104 can be in communication with the ground control station 212 through one or more sets of transceivers, which may facilitate dual path communication in between the first UAV 102 and/or the second UAV 104 and the ground control station 212.

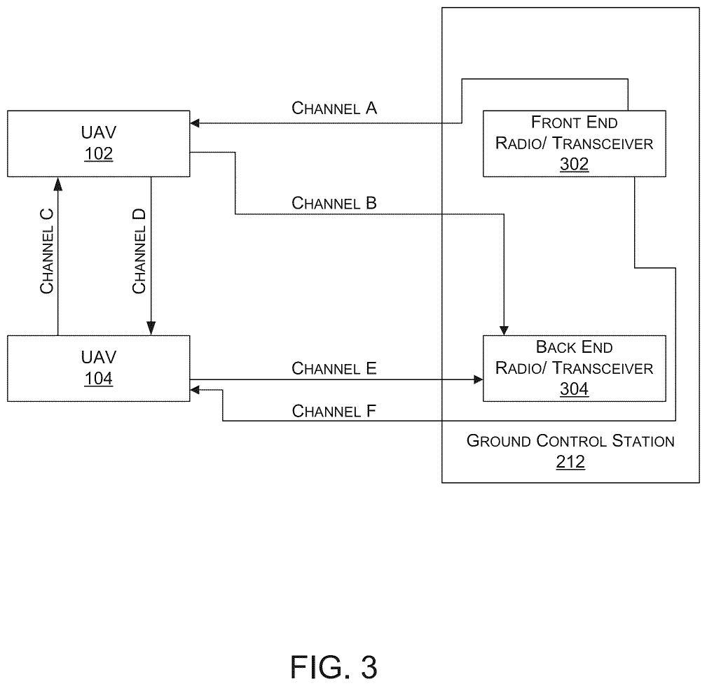

In an implementation, as illustrated in FIG. 3, the ground control station 212 may include a front-end radio or transceiver 302 and a back end radio or transceiver 304, and the first UAV 102 can also have two radios configured for communicating with the station radios 302 and 304. For example, front channel ‘A’ may be a robust, low-bandwidth “primary” channel for sending flight instructions/signals from the ground control station 212 to the first UAV 102. Further, back channel ‘B’ may be used as a “secondary” high-bandwidth channel for transmitting telemetry from the first UAV 102 to the ground control station 212, for the ground control station 212 to transmit signals for supervisory control of the first UAV 102. The back channel could also act as a back up communication channel in case the front end channel fails to connect with at least one of the first UAV 102 and the second UAV 104.

In another embodiment, a dual-path communication is also present between the first UAV 102 and the second UAV 104. Of the two communication channels between the first and the second UAVs 102 and 104, the front channel ‘D’ may be thought of as a robust, low-bandwidth “primary” channel for synchronized motion control from the UAV 102 to the UAV 104. Moreover, back channel ‘C’ may be thought of as a “secondary” high-bandwidth channel, and may be used for transmitting feedback regarding obstacles sensed by the sensors 110 of the UAV 104. Back channel ‘E’ is present between the ground control station 212 and the UAV 104 for manual override control. Furthermore, front end channel ‘F’ may be used for the ground control station 212 to transmit signals for supervisory control or manual override control of the UAV 104, and the back channel ‘E’ is present between the ground control station 212 and the UAV 104 for the UAV 104 to send collected payload/sensor data, telemetry data, and other such data back to the ground control station 212.

In an embodiment, suspension tether wire/line connecting the UAV 104 to the UAV 102 may be fabricated to include at least one break point that may include a release mechanism, such that in case there is a snag at the tether line, the UAV 104 can be unhooked and released from the UAV 102 automatically or through manual instruction from UAV pilot, thus keeping the UAV 102 safe and sound. Further, in the event of an emergency, the UAV 104 may be configured to get detached from the tether and soft land through any or a combination of a propulsion module and a parachute provided with the UAV 104.

In one embodiment, the UAV 104 may identify deflections in tether of the tether and winch mechanism 106 caused due to wind and may transmit a corresponding feedback to the UAV 102 for compensating the deflections, whereas the UAV 102 can compensate the deflections using compensating mechanism.

In other embodiment, the tether and winch mechanism 106 may include a dampening element to prevent swaying of the tether due to wind and aid the UAV 104 in mimicking the horizontal coordinates of the UAV 102. In an instance, the UAV 104 can also send a feedback signal to the UAV 102 indicating deviations present in the tether for correcting the horizontal movement of the UAV 102.

In an exemplary embodiment, the UAV 104 may detect speed of the wind (wind speed, herein) using corresponding sensors 110, such as anemometer. Further, when the wind speed is detected to be above a threshold level, the UAV 104 may trigger an alert signal, and correspondingly the UAV 102 may facilitate the UAV 102 to get unhooked and detached from the tether for safe landing. In a preferred embodiment, the UAV 104 can be circumscribed with an outer cage for providing enhanced safety to the UAV 104.

In an implementation, sway of the tethered UAV 104 can be intricately governed by a fusion of physical principles, sensor data, and sophisticated control algorithms. The UAV 104 may employ an Inertial Measurement Unit (IMU), which may in turn include accelerometers and gyroscopes to measure linear acceleration and angular velocity respectively, hence providing crucial information about orientation and motion of the UAV 104.

In another implementation, load sensors can be present on the tether or within the UAV 104 or on both, to measure forces acting on the tether and/or UAV 104, signalling variations in tension that indicate swaying or movement. The synergy of the sensors' inputs contributes to a comprehensive understanding of the dynamic system 100. Further, kinematics and dynamics modelling may be used, where mathematical models can be employed to encapsulate the motion and forces at play in the tethered UAV 104. Such models may account for parameters such as tether length, UAV system mass, aerodynamic forces, and wind effects, facilitating simulations that predict how the payload will sway under diverse conditions.

In a preferred embodiment, the second UAV 104 may include a control system to process data from these sensors (e.g., IMU and load sensors) in real-time and feedback control algorithms may be incorporated, which may use this data to calculate the necessary adjustments to minimize sway of the second UAV 104. In an exemplary embodiment, Proportional-Integral-Derivative (PID) controllers or more advanced control strategies may be employed for stabilization.

Further, the control system may operate in a closed-loop fashion continuously receiving feedback and dynamically adjusting control inputs of the second UAV 104, such as rotor speeds and tether tension, aiming to maintain stability and minimize disturbances in the form of sway in the second UAV 104. The feedback can also be given to the first UAV 102 such that the UAV 102 may in turn give control information to the tether and winch mechanism 106 for facilitating in controlling tension of the tether. In another embodiment, the UAV 102 may directly give the feedback information to an independent tether tension control system for facilitating in controlling tension of the tether. Facilitated by the tether and winch mechanism 106 and tension sensors, the tether tension control system may actively counteract sway, ensuring a stable position for the second UAV.

In an embodiment, environmental conditions such as wind velocity and wind direction, monitored through wind sensors, may also contribute to anticipatory adjustments. Advanced control algorithms can also be employed such that they can adjust parameters dynamically based on the changing conditions, exemplifying the intricate real-time processing demands handled by the UAVs' 102 and/or 104 computational power. For example, if the UAV 102 and/or 104 detects an increase in wind speed, the control system may adapt its response to provide more aggressive stabilization.

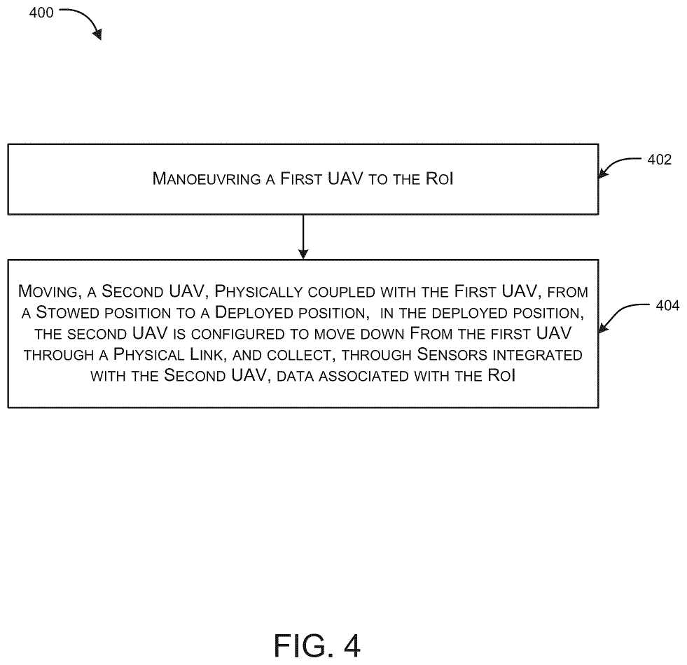

Referring to FIG. 4, the proposed method 400 (also, referred to as method 400, herein) is utilized for inspection of a Region of Interest (RoI) 210. The method 400 includes, at block 402, manoeuvring, a first Unmanned Aerial Vehicle (UAV) 102, to the Region of Interest (RoI) 210. In an embodiment, the UAV 102 is initially located at a remotely located UAV dock station. Upon being triggered by sets of signals transmitted from the UAV dock station, where the sets of signals pertain to location and trajectory of the RoI 210, the first UAV 102 can be configured to take flight from the UAV dock station and manoeuvre to the RoI 210.

The method 400 further includes, at block 404, moving, a second UAV 104, physically coupled with the first UAV 102, from a stowed position to a deployed position with respect to the first UAV 102, upon reaching the RoI 210. In the deployed position, the second UAV 104 is configured to move down from the first UAV 102 through a physical link, and collect, through one or more sensors 110 integrated with the second UAV 104, data associated with the RoI 210. In an exemplary embodiment, the one or more sensors 110 including, but not limited to camera, RADAR, LiDAR, integrated with the second UAV 104, data associated with the RoI 210. In an exemplary embodiment, the camera can be selected from any of daylight RGB camera, thermal camera, multispectral camera, hyperspectral camera, ultrasonic camera, and the like.

In an embodiment, the physical link may be a tether driven by a winch mechanism 106 (also, referred to as tether and winch mechanism 106, herein) through which the second UAV 104 may be coupled to the first UAV 102. The tether and winch mechanism 106 can be provided at the first UAV 102. The second UAV 104 may also be coupled to the first UAV 102 through suspension assembly, wires, rods, and other such mechanisms, which is well within the scope of the invention.

In an embodiment, in the event of an emergency, the method 400 may include detaching the second UAV 104 from the tether and enabling soft landing through any or a combination of a propulsion module and a parachute provided with the second UAV 104.

In one embodiment, in the deployed position of the second UAV 104, the method 400 may include maintaining desired horizontal coordinates of the second UAV 104.

In other embodiment, the method 400 can include identifying, through the second UAV 104, deflections in the tether caused due to wind and transmitting a corresponding feedback to the first UAV 102 for compensating the deflections by changing its own position. In another embodiment, the method 400 can include preventing, through a dampening element associated with the tether and winch mechanism 106, swaying of the tether due to wind. Further, in case wind speed is detected to be above a threshold level, the method 400 can include triggering, through the second UAV 104, an alert signal, and correspondingly facilitating the second UAV 104 to detach from the tether for safe landing.

In an embodiment, the method 400 can include enabling the UAV 102 and the UAV 104 to interact with each other via a communication module 108 preferably through wireless communication channels including, but not limited to, Wi-Fi, Bluetooth, GSM, 4G, 5G, LoRa, NFC (Near Field Communication), and LTE.

In one embodiment, the UAV 102 may determine horizontal coordinates for manoeuvring and may transmit corresponding information to the UAV 104 through the communication module 108, and further, through controlled actuation of the tether and winch mechanism 106, the UAV 104 may move vertically mimicking the horizontal coordinates of the UAV 102 for efficiently collecting the data associated with the RoI 210.

In other embodiment, the UAV 104 may determine horizontal coordinates for manoeuvring and may move vertically, through controlled actuation of the tether and winch mechanism 106, for efficiently collecting the data associated with the RoI 210, and may further transmit corresponding information to the UAV 102 through the communication module 108. The UAV 104 can move vertically with respect to the UAV 102 adjusting altitude by reeling in and out through the tether and winch mechanism 106 for carrying out the inspection efficiently and also for handling emergencies.

In an embodiment, the method 400 can include supplying required electric power from any or a combination of the first UAV 102 and a power supply module integrated within the second UAV 104 to the second UAV 104 for facilitating movement between the stowed position and the deployed position and controlling operations of the one or more sensors 110 integrated along with.

The proposed system 100 and the method 400 can be used for inspection or survey of any of the following including but not limited to cell towers, buildings, gas pipelines, nuclear radiator sites, and the like. Also, upon implementation of the proposed system 100 and/or the method 400, the entire process of performing inspections is automated needing very minimal manual intervention.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all the groups used in the appended claims.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

### Advantages of the Present Disclosure

The present invention provides an effective solution for accurate inspection of distinct regions.

The present invention enables minimization of manual intervention.

The present invention optimizes UAV design for greater autonomy, longer endurance, and improved adaptability.

The present invention prevents UAVs from potential damages, where the larger UAV is prevented from damages by detaching smaller UAV in case of any snag, and the smaller UAV is enabled to carry out soft landing, hence preventing any damages

The present invention enables UAVs to efficiently cover long distances, complex terrains, and operate for extended time duration.

We claim:

1. A system (100) for inspection of a Region of Interest (RoI) (210), comprising:
a first Unmanned Aerial Vehicle (UAV) (102) configured to manoeuvre to the RoI (210); and
a second UAV (104) physically coupled with the first UAV (102), wherein:
upon reaching the RoI (210), the second UAV (104) is configured to move from a stowed position to a deployed position with respect to the first UAV (102), wherein the second UAV (104), in the deployed position, is configured to move down from the first UAV (102) through a physical link, and collect, through one or more sensors (110) integrated with the second UAV (104), data associated with the RoI (210).

2. The system (100) as claimed in claim 1, wherein the physical link is a tether driven by a winch mechanism (106) provided at the first UAV (102).

3. The system (100) as claimed in claim 2, wherein in the event of an emergency, the second UAV (104) is configured to get detached from the tether and soft land through any or a combination of a propulsion module and a parachute provided with the second UAV (104).

4. The system (100) as claimed in claim 2, wherein the winch mechanism (106) comprises a dampening element to prevent swaying of the tether due to wind.

5. The system (100) as claimed in claim 2, wherein when wind speed is detected to be above a threshold level, the second UAV (104) triggers an alert signal, and correspondingly the first UAV (102) facilitates the second UAV (104) to detach from the tether for safe landing.

6. The system (100) as claimed in claim 1, wherein, in the deployed position of the second UAV (104), the system (100) is configured to maintain desired horizontal coordinates of the second UAV (104).

7. The system (100) as claimed in claim 6, wherein the second UAV (104) identifies deflections in the tether caused due to wind and transmits a corresponding feedback to the first UAV (102) for compensating the deflections by changing its own position.

8. The system (100) as claimed in claim 6, wherein the first UAV (102) and the second UAV (104) are configured to interact with each other through a communication module (108), wherein the first UAV (102) determines horizontal coordinates for manoeuvring and transmits corresponding information to the second UAV (104) through the communication module (108), and further, through controlled actuation of the winch mechanism (106), the second UAV (104) moves vertically for efficiently collecting the data associated with the RoI (210).

9. The system (100) as claimed in claim 4, wherein the first UAV (102) and the second UAV (104) are configured to interact with each other through a communication module (108), wherein the second UAV (104) determines horizontal coordinates for manoeuvring, and moves vertically, through controlled actuation of the winch mechanism (106), for efficiently collecting the data associated with the RoI (210), and further transmits corresponding information to the first UAV (102) through the communication module (108).

10. The system (100) as claimed in claim 1, wherein the first UAV (102) and the second UAV (104) are in communication with a ground control station (212) through one or more sets of transceivers, which facilitate dual path communication in between the first UAV (102) and/or the second UAV (104) and the ground control station (212).

11. The system (100) as claimed in claim 1, wherein the second UAV (104) is circumscribed with an outer cage for providing enhanced safety to the second UAV (104).

12. The system (100) as claimed in claim 1, wherein the second UAV (104) moves between the stowed position and the deployed position and controls operations of the one or more sensors (110) integrated along with through electrical power supplied from any or a combination of the first UAV (102) and a power supply module integrated within the second UAV (104).

13. A method (400) for inspection of a Region of Interest (RoI), comprising:
manoeuvring (402), a first Unmanned Aerial Vehicle (UAV), to the Region of Interest (RoI); and
moving (404), a second UAV, physically coupled with the first UAV, from a stowed position to a deployed position with respect to the first UAV, upon reaching the RoI, wherein the second UAV, in the deployed position, is configured to move down from the first UAV through a physical link, and collect, through one or more sensors integrated with the second UAV, data associated with the RoI.

14. The method (400) as claimed in claim 13, wherein the physical link is a tether driven by a winch mechanism provided at the first UAV;
wherein in the event of an emergency, the method (400) comprises detaching the second UAV from the tether and enabling soft landing through any or a combination of a propulsion module and a parachute provided with the second UAV.

15. The method (400) as claimed in claim 14, wherein the method (400) comprises preventing, through a dampening element associated with the winch mechanism, swaying of the tether due to wind.

16. The method (400) as claimed in claim 14, wherein when wind speed is detected to be above a threshold level, the method (400) comprises triggering, through the second UAV, an alert signal, and correspondingly facilitating the second UAV to detach from the tether for safe landing.

17. The method (400) as claimed in claim 13, wherein in the deployed position of the second UAV, the method (400) comprises maintaining desired horizontal coordinates of the second UAV.

18. The method (400) as claimed in claim 17, wherein the method (400) comprises identifying, through the second UAV, deflections in the tether caused due to wind and transmitting a corresponding feedback to the first UAV for compensating the deflections by changing its own position.

19. The method (400) as claimed in claim 17, wherein the method (400) comprises enabling the first UAV and the second UAV to interact with each other through a communication module, wherein the first UAV determines horizontal coordinates for manoeuvring and transmits corresponding information to the second UAV through the communication module, and further, through controlled actuation of the winch mechanism, the second UAV moves vertically for efficiently collecting the data associated with the RoI.

20. The method (400) as claimed in claim 17, wherein the method (400) comprises enabling the first UAV and the second UAV to interact with each other through a communication module, wherein the second UAV determines horizontal coordinates for manoeuvring, and moves vertically, through controlled actuation of the winch mechanism, for efficiently collecting the data associated with the RoI, and further transmits corresponding information to the first UAV through the communication module.

21. The method (400) as claimed in claim 13, wherein the method (400) comprises supplying required electric power from any or a combination of the first UAV and a power supply module integrated within the second UAV to the second UAV for facilitating movement between the stowed position and the deployed position and controlling operations of the one or more sensors integrated along with.
